(19) United States
(12) Patent Application Publication
(10) Pub. No.: US 2025/0045740 A1
(43) Pub. Date: Feb. 6, 2025

(54) METHOD FOR CONTROL DISPERSED TRANSACTION ANALYSIS SYSTEM FOR ANALYZING TRANSACTION BASED ON DISPERSED WORKFLOW AND APPARATUS FOR PERFORMING THE METHOD

(71) Applicant: aiZEN Global Co., lnc., Seoul (KR)

(72) Inventor: Jung Seok KANG, Seoul (KR)

(21) Appl. No.: 18/455,817

(22) Filed: Aug. 25, 2023

(30) Foreign Application Priority Data
Aug. 2, 2023 (KR) 10-2023-0101209

(51) Int. Cl. G06Q 20/38

(52) U.S. Cl. CPC G06Q 20/3821

(57) ABSTRACT

A method of controlling a distributed transaction analysis system for analyzing a transaction on the basis of a distributed workflow and a device for performing the method can include controlling, by a serving container manager (SCM) for the distributed transaction analysis system, a plurality of analysis groups included in a worker part and controlling, by the SCM for the distributed transaction analysis system, full-text division of a codec.

### BACKGROUND

### 1. Field of the Invention

The present invention relates to a method of controlling a distributed transaction analysis system for analyzing a transaction on the basis of a distributed workflow and a device for performing the method. More specifically, the present invention relates to a method of controlling a distributed transaction analysis system for analyzing a transaction on the basis of a distributed workflow which is intended to divide full text and analyze a transaction of which the full text is divided in order to analyze the transaction caused by a payment through a workflow distributed on the basis of full-text division, and a device for performing the method.

### 2. Discussion of Related Art

Due to the rapid increase in various financial scams and voice phishing based on the complexity and diversification of financial services and products, there is an increasing necessity to introduce a fraud detection system (FDS) for detecting an abnormal transaction in real time and preventing any damage.

Since long ago, the insurance industry has introduced and implemented an FDS in subscription review or payment review to detect unfair claims for insurance money based on intentional accidents or unfair subscriptions and claims using the blind spots of insurance rather than a common-sense level of insurance. Almost all insurance companies have built and run their own FDS.

Card companies, banks, and securities companies also have introduced an FDS. The principle of FDSs involves modeling features of types of scams or abnormal transactions and predefining transaction patterns shown in the types of scams or abnormal transactions, thereby allowing a person in charge to analyze or determine whether such a pattern of a transaction is a fraudulent transaction or a normal transaction and handle the transaction.

Therefore, the most important part of building an FDS is to model abnormal transactions or fraudulent transactions and pattern and input the models to the FDS. Many FDSs still employ such a rule-based system.

However, to prevent fraudulent transactions or abnormal transactions that are becoming more and more intelligent and sophisticated, a model evolving from an existing model is necessary. To this end, attempts are being made to create and apply a predictive model using artificial intelligence capable of learning, but there are still may things to be done to improve their effectiveness.

The present invention has been developed through “FinTech Blockchain Technology Commercialization Support Project in 2020” and “Development of AI Detection Solution Specialized for Voice Phishing and Anti-Money Laundering (AML)” by Seoul Business Agency of the Seoul Metropolitan Government.

The related art is Korean Patent Application No. 10-2020-0162698.

### SUMMARY OF THE INVENTION

The object of the present invention is to solve all of the foregoing problems.

The present invention is directed to rapidly analyzing a transaction through full-text division and queue division.

The present invention is also directed to adaptively distributing computing resources for artificial intelligence engines and rapidly analyzing a transaction.

A representative configuration of the present invention for achieving the above objects is as follows.

According to an aspect of the present invention, there is provided a method of controlling a distributed transaction analysis system for analyzing a transaction on the basis of a distributed workflow comprises controlling, by a serving container manager (SCM) for the distributed transaction analysis system, a plurality of analysis groups included in a worker part and controlling, by the SCM for the distributed transaction analysis system, full-text division of a codec.

Meanwhile, each of the analysis groups includes at least one artificial intelligence engine, and the SCM determines addition and deletion of the analysis groups included in the worker part and a number of artificial intelligence engines which are included in the analysis groups and loaded into a memory to operate.

Further, the SCM controls the codec by considering a plurality of sub-request transactions input to the artificial intelligence engines so that full text of a request transaction input from a transaction service part is divided by the codec.

According to another aspect of the present invention, there is provided a distributed transaction analysis system for analyzing a transaction on the basis of a distributed workflow comprises a serving container manager (SCM) configured to control a plurality of analysis groups included in a worker part and control full-text division of a codec.

Meanwhile, each of the analysis groups includes at least one artificial intelligence engine, and the SCM determines addition and deletion of the analysis groups included in the worker part and a number of artificial intelligence engines which are included in the analysis groups and loaded into a memory to operate.

Further, the SCM controls the codec by considering a plurality of sub-request transactions input to the artificial intelligence engines so that full text of a request transaction input from a transaction service part is divided by the codec.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram of a distributed transaction analysis system according to an exemplary embodiment of the present invention.

FIG. 2 is a conceptual diagram of a full-text division operation of a codec according to an exemplary embodiment of the present invention.

FIG. 3 is a conceptual diagram of a request and response operation based on full-text division of a codec according to an exemplary embodiment of the present invention.

FIG. 4 is a conceptual diagram of queue division according to an exemplary embodiment of the present invention.

FIG. 5 is a conceptual diagram illustrating a method of providing artificial intelligence engines to an analysis group according to an exemplary embodiment of the present invention.

FIG. 6 is a conceptual diagram of a full-text division method according to an exemplary embodiment of the present invention.

FIG. 7 is a conceptual diagram illustrating queue division according to an exemplary embodiment of the present invention.

FIG. 8 is a conceptual diagram illustrating a method of allocating computing resources to analysis groups according to an exemplary embodiment of the present invention.

FIG. 9 is a conceptual diagram illustrating an artificial engine exchange method according to an exemplary embodiment of the present invention.

FIG. 10 is a conceptual diagram illustrating an artificial intelligence engine specialization method according to an exemplary embodiment of the present invention.

FIG. 11 is a conceptual diagram illustrating an operation of a distributed transaction analysis system based on a plurality of transaction service parts according to an exemplary embodiment of the present invention.

### DETAILED DESCRIPTION OF EXEMPLARY EMBODIMENTS

The detailed description of the present invention will be made with reference to the accompanying drawings showing examples of specific embodiments of the present invention. These embodiments will be described in detail such that the present invention can be performed by those skilled in the art. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or arrangement of each component in each disclosed embodiment may be changed without departing from the scope and spirit of the present invention. Accordingly, there is no intent to limit the present invention to the detailed description to be described below. The scope of the present invention is defined by the appended claims and encompasses all equivalents that fall within the scope of the appended claims. Like reference numerals refer to the same or like elements throughout the description of the figures.

Hereinafter, in order to enable those skilled in the art to practice the present invention, exemplary embodiments of the present invention will be described in detail with reference to the accompanying drawings.

Hereinafter, exemplary embodiment of the present invention will be described on the assumption that a transaction includes financial transaction information (e.g., information on a payment with a card) for convenience of description. However, a transaction may include information related to various transactions such as cryptocurrency transaction information, battery transaction information, and the like.

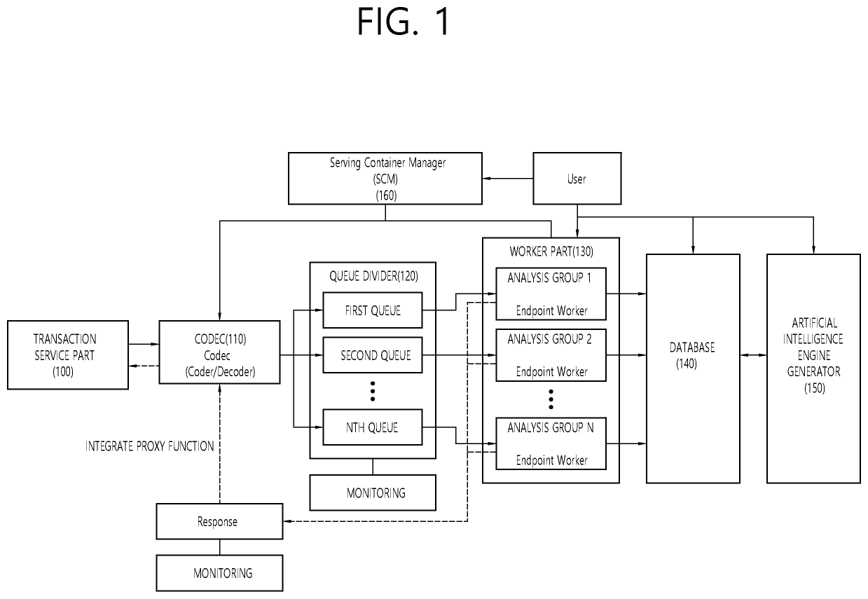

FIG. 1 is a conceptual diagram of a distributed transaction analysis system according to an exemplary embodiment of the present invention.

FIG. 1 shows a distributed transaction analysis system for analyzing a transaction.

Referring to FIG. 1, the distributed transaction analysis system may include a transaction service part 100, a codec 110, a queue divider 120, a worker part 130, a database 140, an artificial intelligence engine generator 150, and a serving container manager (SCM) 160.

The transaction service part 100 may generate a transaction on the basis of a service and transmit the transaction to a codec to analyze the transaction according to the service. For example, the transaction service part 100 may transmit a transaction made by a payment with a card of a specific card company to the distributed transaction analysis system. The transaction service part 100 may be construed as a service unit that provides a specific transaction service.

The transaction service part 100 may transmit a request transaction for requesting analysis to the codec 110. After analysis of the request transaction, the transaction service part 100 may receive a response transaction from the codec 110 as an analysis result based on the request transaction.

The codec 110 may divide full text of a request transaction and combine the full text for generating a response transaction. For example, the codec 110 may separate necessary information from the request transaction by dividing full text of the request transaction and thus generate a plurality of sub-request transactions. Alternatively, the codec 110 may convert one request transaction into a plurality of request transactions. For example, when a plurality of analyses (e.g., a domestic abnormal transaction analysis, a foreign abnormal transaction analysis, a foreign transaction prerejection (payment rejection in advance) analysis, and the like) are necessary on the basis of a transaction, a plurality of sub-request transactions including information required for the plurality of analyses may be generated by the codec 110.

Also, the codec 110 may generate a response transaction by combining full text of a plurality of sub-response transactions including an analysis result generated on the basis of analysis of a plurality of sub-request transactions of a plurality of analysis groups.

The codec 110 may divide the full text of the request transaction on the basis of an analysis group change such as an analysis group update, an analysis group addition, or an analysis group alteration. The analysis group alteration may be caused by a change of an analysis target or a change of an artificial intelligence engine that performs the analysis, and the codec 110 may divide the full text of the request transaction in consideration of the analysis group change.

The queue divider 120 may divide a queue according to an analysis group. The plurality of analysis groups may be included in the worker part 130, and a plurality of queues for inputting sub-request transactions to the plurality of analysis groups may be separately assigned to the plurality of analysis groups. A sub-request transaction of each analysis group may be transmitted to the analysis group through a separate queue.

The queue divider 120 may divide queues on the basis of throughput required for each analysis group. The queue divider 120 may assign a relatively large number of queues to an analysis group with a relatively large throughput. On the other hand, the queue divider 120 may assign a relatively small number of queues to an analysis group with a relatively small throughput.

The worker part 130 may perform analysis on the basis of a sub-request transaction. The worker part 130 may include a plurality of analysis groups, and the plurality of analysis groups may receive a plurality of sub-request transactions and perform analysis on the basis of the plurality of sub-request transactions. Each of the plurality of analysis groups may include an endpoint worker, which may be a sub-request transaction analysis unit including an artificial intelligence engine.

For example, full text of a request transaction may be divided into sub-request transaction 1, sub-request transaction 2, and sub-request transaction 3 by the codec 110. Sub-request transaction 1, sub-request transaction 2, and sub-request transaction 3 may be transmitted to analysis group 1, analysis group 2, and analysis group 3 on the basis of separate queues (e.g., a first queue, a second queue, and a third queue), respectively. Analysis group 1, analysis group 2, and analysis group 3 may output a first analysis result (e.g., a foreign prerejection analysis result), a second analysis result (e.g., an abnormal transaction analysis result), and a third analysis result (e.g., an illegal affiliate transaction analysis result), respectively.

Each of the plurality of analysis groups may include an artificial intelligence engine for generating an analysis result. The artificial intelligence engine may be generated by the artificial intelligence engine generator 150 and transmitted to the plurality of analysis groups.

The artificial intelligence engine included in each of the plurality of analysis groups may be changed according to performance. Each of the plurality of analysis groups may include at least one artificial intelligence engine for generating a specific analysis result, and the at least one artificial intelligence engine may be compared with a new artificial intelligence engine in terms of analysis performance and changed.

Also, computing resources may be allocated to the plurality of analysis groups differently depending on throughput. For example, when analysis group 1 corresponds to necessary analysis and outputs analysis results of all transactions, a relatively large amount of computing resources may be allocated to analysis group 1, and when analysis group 2 performs selective analysis on foreign transactions and outputs analysis results, a relatively small amount of computing resources may be allocated to analysis group 2.

Computing resources may include the number of artificial intelligence engines, a graphics processing unit (GPU), memory resources, and the like. In the present invention, analysis groups of the worker part 130 may be uploaded to a memory and operate for rapid analysis, and such memory resources may be allocated in consideration of the throughput of each analysis group adaptively and differently depending on analysis group.

The database 140 may store data for operations of the worker part 130 and the artificial intelligence engine generator 150. The database 140 may store information on a transaction which has taken place, and the stored transaction information may be used for analysis of the worker part 130 in an analysis group and learning of a candidate artificial intelligence engine in the artificial intelligence engine generator 150.

The artificial intelligence engine generator 150 may generate an artificial intelligence engine for transaction analysis. The artificial intelligence engine generator 150 may generate various artificial intelligence engines for generating analysis results on the basis of transactions accumulated in the database 140.

A new candidate artificial intelligence engine generated by the artificial intelligence engine generator 150 may be compared with a target artificial intelligence engine used in a current analysis group in terms of performance, and the target artificial intelligence engine may be changed for the candidate artificial intelligence engine in consideration of performance improvement.

The SCM 160 may control an analysis group and the codec 110. The SCM 160 may perform change of an artificial intelligence engine in an analysis group, addition, deletion, or change of an analysis group in the worker part 130, and the like. Also, to generate a sub-request transaction corresponding to an analysis group, the SCM 160 may interoperate with the codec to control full-text division of a transaction or full-text combining of a transaction by the codec 110. For example, when an analysis group is added, information on a sub-request transaction to be generated is transmitted to the codec 110 to generate the sub-request transaction to be input to the added analysis group, and the codec 110 may generate the sub-request transaction by dividing full text of the request transaction on the basis of the information on the sub-request transaction.

Full-text division and full-text combining based on the codec 110 will be described in detail below.

As described above, transactions per second (TPS) can be increased through resource allocation in which throughput of an analysis group is taken into consideration and separate processing of a transaction based on full-text division and full-text combining.

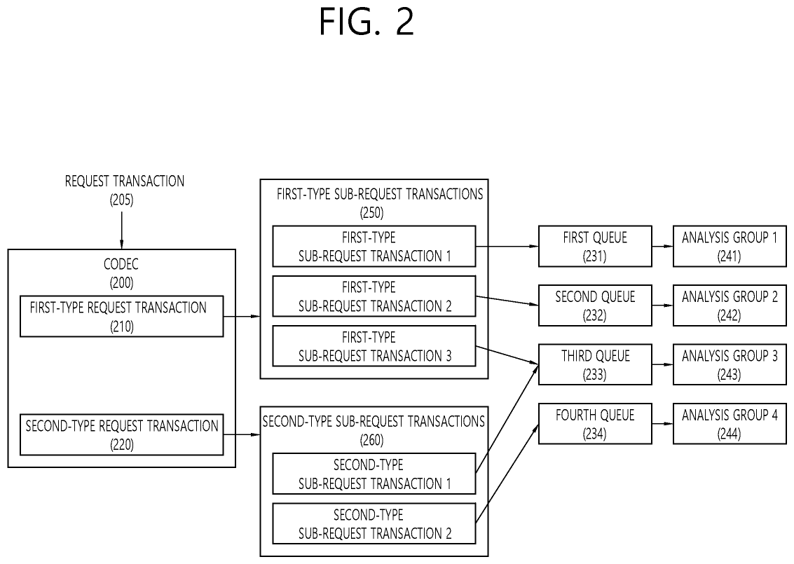

FIG. 2 is a conceptual diagram of a full-text division operation of a codec according to an exemplary embodiment of the present invention.

FIG. 2 shows an operation of dividing full text of a request transaction which is performed in a codec.

Referring to FIG. 2, a codec 200 may perform full-text division for each request transaction 205 on the basis of identification information of the request transaction 205 received from a transaction service part.

Each request transaction 205 may be transmitted to a different analysis group and then analyzed. For example, the codec 200 may identify a request transaction type on the basis of an identifier of the request transaction 205 and divide full text by considering analysis required for the request transaction 205 depending on the request transaction type. A transaction type may be identified on the basis of information on the request transaction 205 rather than the identifier.

For example, a first-type request transaction 210 may be a domestic card transaction, and a second-type request transaction 220 may be a foreign card transaction. The first-type request transaction 210 and the second-type request transaction 220 may be distinguished on the basis of request transaction identifiers, and the codec 200 may generate a plurality of first-type sub-request transactions 250 and a plurality of second-type sub-request transactions 260 by differently dividing full text of the first-type request transaction 210 and the second-type request transaction 220, respectively.

The plurality of first-type sub-request transactions 250 may be determined on the basis of information to be input to analysis groups through queues divided in consideration of analysis required for the first-type request transaction 210. The plurality of second-type sub-request transactions 260 may be determined on the basis of information to be input to analysis groups through queues divided in consideration of analysis required for the second-type request transaction 220.

For example, the first-type request transaction 210 may be divided into three first-type sub-request transactions (first-type sub-request transaction 1, first-type sub-request transaction 2, and first-type sub-request transaction 3) 250, and the three first-type sub-request transactions 250 may be transmitted to analysis group 1 (241), analysis group 2 (242), and analysis group 3 (243). The three first-type sub-request transactions 250 may be transmitted to analysis group 1 (241), analysis group 2 (242), and analysis group 3 (243) through separate queues (a first queue 231, a second queue 232, and a third queue 233) which correspond to analysis group 1 (241), analysis group 2 (242), and analysis group 3 (243), respectively.

The second-type request transaction 220 may be divided into two second-type sub-request transactions (second-type sub-request transaction 1 and second-type sub-request transaction 2) 260, and the two second-type sub-request transactions 260 may be transmitted to analysis group 3 (243) and analysis group 4 (244). The two second-type sub-request transactions 260 may be transmitted to analysis group 3 (243) and analysis group 4 (244) through separate queues (the third queue 233 and a fourth queue 234) which correspond to analysis group 3 (243) and analysis group 4 (244), respectively.

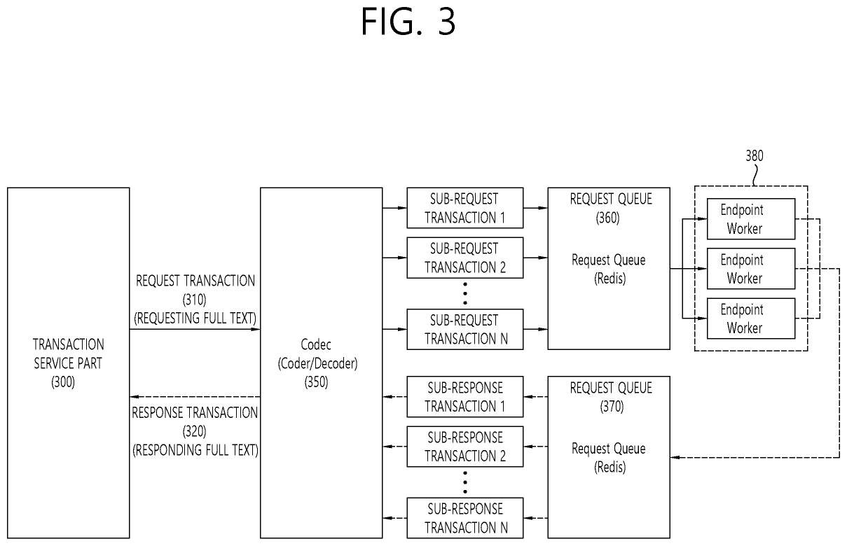

FIG. 3 is a conceptual diagram of a request and response operation based on full-text division of a codec according to an exemplary embodiment of the present invention.

FIG. 3 shows a method of processing a request for a plurality of sub-transactions of which full text is divided and a response to the request.

A transaction transmitted from a transaction service part to a codec may be termed a request transaction, and a transaction transmitted from a codec to a transaction generator may be termed a response transaction. Also, a sub-transaction transmitted from a codec to an analysis group may be termed a sub-request transaction, and a sub-transaction transmitted from an analysis group to a codec may be termed a sub-response transaction.

Referring to FIG. 3, a specific type of request transaction 310 may be divided into a plurality of sub-request transactions through a codec 350. The plurality of sub-request transactions may be termed full text of a plurality of sub-requests. Sub-request transaction 1 to sub-request transaction n may be input to a plurality of separate request queues 360 and input to endpoint workers of analysis group 1 to analysis group n in the plurality of separate request queues 360. The endpoint workers 380 may be construed as modules that include artificial intelligence engines operating in analysis groups and output analysis results.

The endpoint workers 380 of analysis group 1 to analysis group n may generate analysis result 1 to analysis result n based on the input sub-request transactions. Analysis result 1 to analysis result n may be transmitted to the codec 350 as a plurality of sub-response transactions. The plurality of sub-response transactions may be termed full text of a plurality of responses. Full text of the plurality of sub-response transactions may be combined and transmitted to a transaction service part 300 as a response transaction 320.

There may be a difference in processing time between the plurality of sub-request transactions. For example, when a relatively large number of sub-request transactions are preassigned to a separate queue corresponding to a specific analysis group or artificial intelligence engines corresponding to endpoint workers 380 of analysis groups have different processing times, a plurality of sub-response transactions may be transmitted to the codec 350 at different times.

According to an exemplary embodiment of the present invention, when a plurality of sub-request transactions are divided, it may be identified from which transaction the plurality of sub-request transactions have been divided on the basis of an identification value such as a hash value. The response transaction 320 obtained by combining full text of the plurality of sub-response transactions which are input at different times on the basis of such identification values in the codec 350 may be transmitted to the transaction service part 300.

A timeout period is set in the codec 350. A sub-response transaction that is not received within the timeout period may be excluded, and full text of other sub-response transactions may be combined and transmitted to the transaction service part 300 as a response transaction. For example, when sub-response transaction 3 is not transmitted within the timeout period among sub-response transaction 1, sub-response transaction 2, and sub-response transaction 3, full text of only sub-response transaction 1 and sub-response transaction 2 may be combined and transmitted to the transaction service part 300 as the response transaction 320.

The timeout period may be determined in consideration of a service of the transaction service part 300, analysis group processing time information which is information on a time required for each of a plurality of analysis groups to generate an analysis result, and analysis group queue waiting information which is information on the volume of sub-request transactions waiting in a queue of an analysis group in time units.

Also, the timeout period may be set differently depending on the importance of each analysis result. When an analysis result is relatively important in determining whether to approve a transaction, the importance of the analysis result may have a relatively high value. For an analysis result to be rapidly transmitted among a plurality of analysis results of one request transaction, a shorter timeout period than a general timeout period may be set. When another analysis result is not received within the shorter timeout period, one response transaction may be rapidly generated from the analysis result and transmitted to the transaction service part 300.

Alternatively, according to an exemplary embodiment of the present invention, a plurality of sub-request transactions of one request transaction may be set as a plurality of sub-request transaction groups and then input to analysis groups. Different timeout periods may be set for the plurality of sub-request transaction groups. For example, a request transaction may be divided into a first sub-request transaction group and a second sub-request transaction group through the codec 350. Individual timeout periods may be set for sub-response transactions with respect to the first sub-request transaction group and the second sub-request transaction group. Full text of sub-request transactions included in the first sub-request transaction group and full text of sub-request transactions included in the second sub-request transaction group may be divided on the basis of different identifiers (e.g., hash values), separately combined later, and transmitted to the transaction service part 300. In this way, sub-request transactions of which analysis results are relatively rapidly required and sub-request transactions of which analysis results are not relatively rapidly required may be separately grouped, and response transactions may be generated and transmitted to the transaction service part 300.

Also, according to an exemplary embodiment of the present invention, when a request transaction is divided into a plurality of sub-request transaction groups, group identifiers (e.g., group hash values) for combining full text of the plurality of sub-request transaction groups may be separately allocated. When sub-response transactions for the plurality of sub-request transaction groups are received within a full-text combining time, full text of sub-response transactions for the plurality of sub-request transaction groups may be combined, and thus a response transaction may be generated and transmitted.

Also, whether to generate sub-request transactions may be determined in consideration of current analysis group processing time information and analysis group queue waiting information. When a generation time of a sub-response transaction estimated on the basis of a current analysis group processing time information and analysis group queue waiting information exceeds a threshold timeout period, a sub-request transaction group may be generated, and thus a rapid response transaction may be generated. A sub-request transaction of which a generation time is estimated to be longer than the threshold timeout period may be classified into a sub-request transaction group through grouping.

In this way, an analysis result of a transaction can be rapidly transmitted due to separate and individual analyses of sub-request transactions.

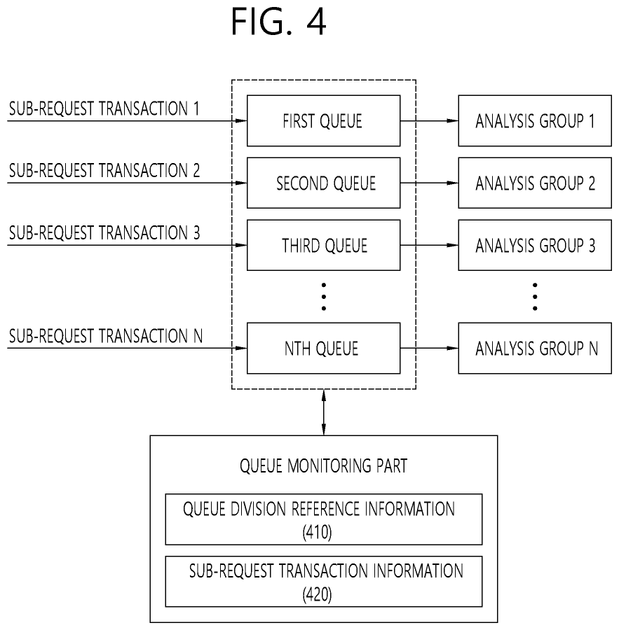

FIG. 4 is a conceptual diagram of queue division according to an exemplary embodiment of the present invention.

FIG. 4 shows a queue division operation for processing sub-request transactions.

Referring to FIG. 4, a plurality of sub-request transactions may be input to analysis groups through separate queues corresponding to the analysis groups.

For example, full text of a request transaction may be divided into sub-request transaction 1, sub-request transaction 2, and sub-request transaction 3 by a codec.

Sub-request transaction 1, sub-request transaction 2, and sub-request transaction 3 may be assumed to be input to analysis group 1, analysis group 2, and analysis group 3, respectively. Sub-request transaction 1, sub-request transaction 2, and sub-request transaction 3 may be assigned to a first queue, a second queue, and a third queue which are separate, respectively.

Previously input sub-request transactions may be placed in the first to third queues. Sub-request transaction 1, sub-request transaction 2, and sub-request transaction 3 respectively placed in the first, second, and third queues may be input to analysis group 1, analysis group 2, and analysis group 3 and processed according to processing of each individual queue.

According to an exemplary embodiment of the present invention, a queue may be set in consideration of a change of analysis groups (addition or deletion), a change in the throughput of an analysis group, a change of an artificial intelligence engine corresponding to an analysis group, and the like.

A queue monitoring part may monitor queue division reference information 410. Alternatively, the queue monitoring part may monitor information 420 on sub-request transactions accumulated in queues. A queue corresponding to an analysis group may be assigned on the basis of the monitored queue division reference information 410. The queue division reference information 410 may include a change of analysis groups (addition or deletion), a change in the throughput of an analysis group, a change of an artificial intelligence engine corresponding to an analysis group, and the like.

For example, an SCM may adaptively adjust the number of endpoint workers (or the number of artificial intelligence engines) included in an analysis group and/or add and remove an analysis group. Assigned queues may be adjusted or a new queue may be assigned according to an adjustment of the number of endpoint workers (or an adjustment of the number of artificial intelligence engines) and addition and removal of an analysis group.

In an analysis group, identical artificial intelligence engines which generate the same analysis result may be present, but different versions of artificial intelligence engines, such as an artificial intelligence engine before retraining and an artificial intelligence engine after retraining, may be present instead of identical artificial intelligence engines. When there are artificial intelligence engine 1 and artificial intelligence engine 2 which are different in an analysis group, different queues may be assigned to the single analysis group to input sub-request transactions to different artificial intelligence engines.

Different artificial intelligence engines in one analysis group may separately operate to generate individual analysis results (independent analysis). On the other hand, different artificial intelligence engines in one analysis group may operate dependently to generate dependent analysis results (dependent analysis).

In the case of independent analysis, a queue assigned to one analysis group may be divided into individual sub-queues for different artificial intelligence engines, and the individual sub-queues may transmit sub-request transactions to the different artificial intelligence engines. Subsequently, when a specific artificial intelligence engine is deleted, a sub-queue corresponding to the deleted artificial intelligence engine may be deleted, and when a specific artificial intelligence engine is added, a sub-queue corresponding to the added artificial intelligence engine may be added.

In the case of dependent analysis, a queue assigned to one analysis group may be copied, and the copied duplicate queues may be connected to different artificial intelligence engines and transmit the same sub-request transaction. The duplicate queues may be queues that transmit the same sub-request transaction as the queue which is the target of duplication (original queue). The duplicate queues may transmit the same sub-request transaction to different artificial intelligence engines in synchronization with each other. In the case of dependent analysis, the original queue and the duplicate queues may set a synchronization range in consideration of analysis result generation times of different artificial intelligence engines so that analysis results of the different artificial intelligence engines may be generated within a certain time range, and may transmit sub-request transactions. Individual sub-queues, an original queue, and duplicate queues may correspond to the concept of a default queue to be described below.

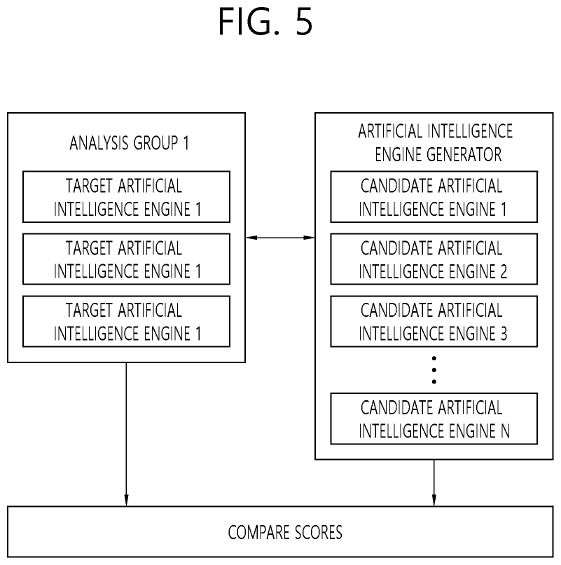

FIG. 5 is a conceptual diagram illustrating a method of providing artificial intelligence engines to an analysis group according to an exemplary embodiment of the present invention.

FIG. 5 shows a method of changing artificial intelligence engines.

Referring to FIG. 5, an artificial intelligence engine generator may generate a plurality of artificial intelligence engines through training based on transactions being accumulated.

An artificial intelligence engine may be trained to generate an analysis result that is identical to or similar to an analysis result extracted from a current analysis group.

For example, it may be assumed that analysis group 1 generates an analysis result on the basis of target artificial intelligence engine 1 for determining foreign prerejection. An artificial intelligence engine used by a current analysis group may be termed a target artificial intelligence engine.

The number of target artificial intelligence engines included in analysis group 1 may be adjusted adaptively to the amount of sub-request transactions input to analysis group 1, and the number of assigned queues may be adjusted adaptively to the number of target artificial intelligence engines.

After target artificial intelligence engine 1 and new candidate artificial intelligence engine 1 newly generated through training are compared in terms of performance, target artificial intelligence engine 1 may be replaced with candidate artificial intelligence engine 1.

To replace a target artificial intelligence engine present in each analysis group, the artificial intelligence engine generator may generate a candidate artificial intelligence engine corresponding to the target artificial intelligence engine of the analysis group.

When performance (e.g., reliability) of a target artificial intelligence engine is higher than performance of a candidate artificial intelligence engine by a threshold score or more, the target artificial intelligence engine may be replaced with the candidate artificial intelligence engine, and the candidate artificial intelligence engine may operate as a new target artificial intelligence engine.

The artificial intelligence engine generator may generate at least one candidate artificial intelligence engine corresponding to a target artificial intelligence engine which corresponds to each analysis group, and the at least one candidate artificial intelligence engine may be set as a new target artificial intelligence engine through comparison with the target artificial intelligence engine.

Also, the artificial intelligence engine generator may train an artificial intelligence engine to be used for an analysis group for generating another analysis result rather than a current analysis group.

According to the present invention, an artificial intelligence engine for generating a specific analysis result is allocated to each analysis group, and the number of allocated artificial intelligence engines and the amount of computing resources used by the artificial intelligence engines are adaptively set according to throughput. Accordingly, the problem of a tier-by-tier increasing amount of memory being used can be solved. Also, the amount of memory being used can be reduced by adaptively adjusting the memory load of artificial intelligence engines of each analysis group. For example, a relatively large number of duplicate artificial intelligence engines are allocated to an analysis group to which a relatively large number of sub-request transactions are input, and a relatively large amount of computing resources can be allocated to the analysis group accordingly.

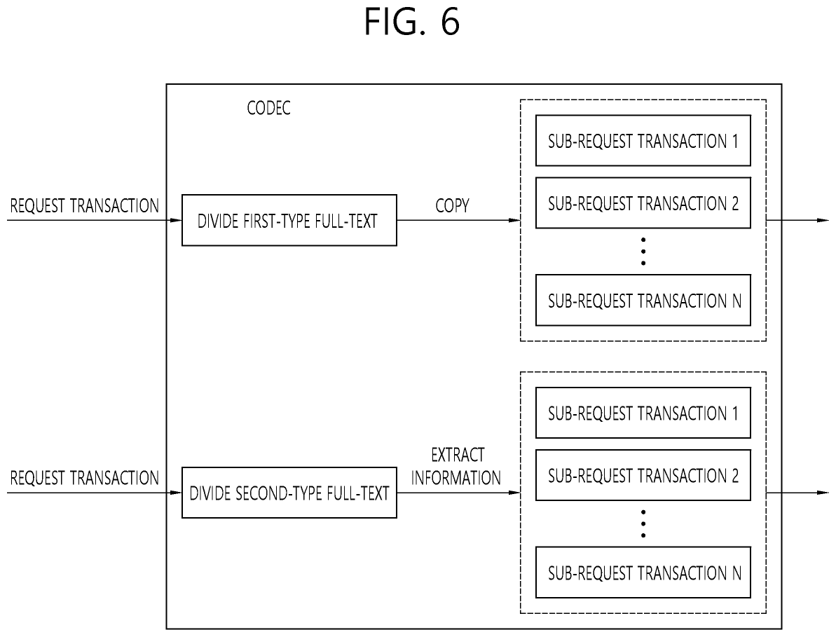

FIG. 6 is a conceptual diagram of a full-text division method according to an exemplary embodiment of the present invention.

FIG. 6 shows a method of dividing full text of a transaction.

Referring to FIG. 6, a request transaction may include information on an analysis identifier and a model identifier. The analysis identifier may include information on analysis to be performed on the request transaction. The model identifier may include information on artificial intelligence engines to be applied to the request transaction.

Full text of the request transaction may be divided on the basis of the analysis identifier and the model identifier so that the request transaction is converted into sub-request transactions. The sub-request transactions may be input to the artificial intelligence engines of analysis groups through separate queues of the analysis groups and then processed.

According to another exemplary embodiment, the request transaction may include transaction identifiers, and a codec may set analysis groups required for the request transaction on the basis of the transaction identifiers and divide the full text of the request transaction into sub-request transactions.

Two types of full-text division may be performed on a transaction.

According to the first-type full-text division, information is not extracted from a request transaction, and a plurality of identical request transactions are generated by copying a request transaction. In other words, the first-type full-text division is a method of generating a plurality of sub-request transactions by copying a request transaction a number of times corresponding to the number of sub-request transactions required for the request transaction.

According to the second-type full-text division, only information required for an analysis group is extracted from a request transaction to generate a sub-request transaction. For example, according to the second-type full-text division, only information required for artificial intelligence engines of analysis groups may be extracted on the basis of an analysis identifier and a model identifier to generate a plurality of sub-request transactions.

According to other-type full-text division, information is not extracted from a request transaction, and unnecessary information is included as null data to generate a sub-request transaction.

The first-type full-text division may be performed when there is a separate artificial intelligence engine for a request transaction and thus a preprocessing procedure for extracting information required for a sub-request transaction may be performed by the artificial intelligence engine or when an artificial intelligence engine is trained on the basis of non-preprocessed request transactions.

The second-type full-text division is for generating standardized sub-request transactions by considering formats of different request transactions. According to the second-type full-text division, sub-request transactions input to artificial intelligence engines may be preprocessed in a codec step.

When a new type of payment transaction takes place, only information required for the new payment transaction may be extracted on the basis of the second-type full-text division for analysis based on an existing artificial intelligence engine, and then an analysis result may be generated.

Subsequently, an artificial intelligence engine for the new type of payment transactions may be trained as a candidate artificial intelligence engine and become a target artificial intelligence engine for analyzing only the new type of payment transactions, and an additional analysis group may be generated for the target artificial intelligence engine. In this case, sub-request transactions may be generated through the first-type full-text division in the codec step without any preprocessing and input to the artificial intelligence engine.

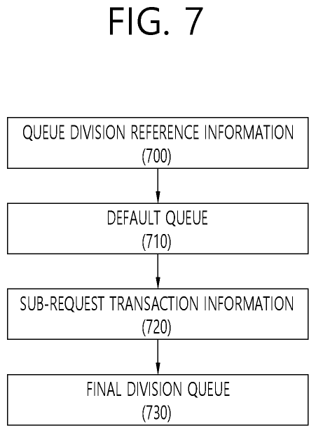

FIG. 7 is a conceptual diagram illustrating queue division according to an exemplary embodiment of the present invention.

FIG. 7 shows a queue division method for sub-request transactions.

Referring to FIG. 7, queue division for analysis groups may be performed on the basis of queue monitoring results.

As described above, a queue monitoring part may monitor queue division reference information 700 and sub-request transaction information 720. The queue division reference information 700 may include a change of analysis groups (addition or deletion), a change in the throughput of an analysis group, a change of an artificial intelligence engine corresponding to an analysis group, and the like. The sub-request transaction information 720 may include information on sub-request transactions input to queues.

First, default queues 710 may be determined on the basis of the queue division reference information 700. The default queues 710 may be determined and allocated on the basis of the queue division reference information 700. For example, when three artificial intelligence engines are allocated to analysis group 1, three queues for the three artificial intelligence engines may be allocated to analysis group 1 as the default queues 710. As another example, when an analysis group is added, the default queues 710 may be allocated to the added analysis group in consideration of the number of initial artificial intelligence engines allocated to the added analysis group, and when an analysis group is deleted, the default queue 710 for the deleted analysis group may be set to “0.” When the number of artificial intelligence engines changes, the number of default queues 710 may be reset according to the number of artificial intelligence engines.

Second, the set default queues 710 may be determined as final division queues 730 on the basis of the sub-request transaction information 720 transmitted through the default queues 710. Accumulation information of sub-request transactions accumulated in the default queues 710 may be monitored as the sub-request transaction information 720. When the number of times that a sub-request transaction having a first threshold value or more is accumulated in the default queues 710 is a first threshold number of times or more, a queue may be added to the default queues 710, and the default queues 710 may be determined as the final division queues 730. On the other hand, when the number of times that a sub-request transaction having less than a second threshold value is accumulated in the default queues 710 is a second threshold number of times or more, some of the default queues 710 may be deleted, and the final division queues 730 may be determined. When the final division queues 730 are determined, artificial intelligence engines may be copied and added to analysis groups and loaded to a memory or deleted from the memory according to the final division queues 730.

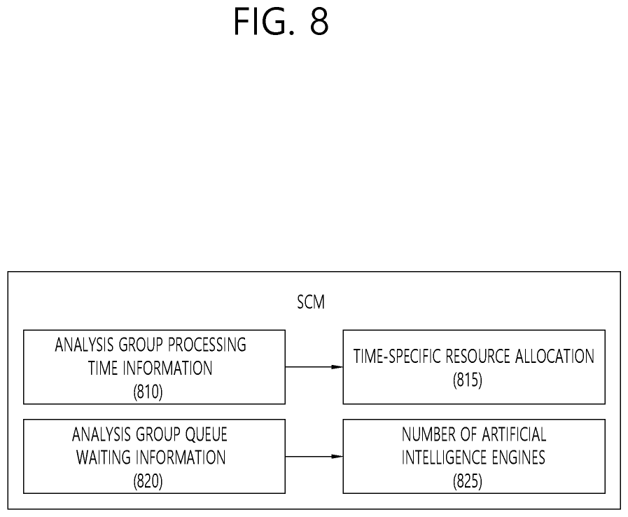

FIG. 8 is a conceptual diagram illustrating a method of allocating computing resources to analysis groups according to an exemplary embodiment of the present invention.

FIG. 8 shows a method of allocating computing resources in consideration of the throughput of an artificial intelligence engine of an analysis group.

Referring to FIG. 8, the amount of a sub-request transaction input to each of a plurality of analysis groups may be different, and each of the plurality of analysis groups may have a different sub-request transaction throughput. Therefore, according to an exemplary embodiment of the present invention, the number of artificial intelligence engines allocated to each analysis group and computing resources (a GPU, a central processing unit (CPU), a memory, and the like) allocated to each analysis group may be set differently and adaptively.

An SCM may receive analysis group processing time information 810 and analysis group queue waiting information 820 which are input at certain time intervals and allocate computing resources. The analysis group processing time information 810 may include information on a time at which a sub-request transaction is processed after the sub-request transaction is input to an analysis group. The analysis group queue waiting information 820 may include information on the volume of sub-request transactions waiting in a queue of an analysis group in time units.

The SCM may adaptively adjust time units to allocate computing resources to analysis groups and adjust the number of artificial intelligence engines of analysis groups.

Time-specific resource allocation 815 may be reset with a first interval on the basis of the analysis group processing time information 810.

The first interval may be adaptively set in consideration of transaction information input at certain time intervals. For example, the amount of a card payment transaction which takes place domestically at the certain time intervals may differ from the amount of a card payment transaction which takes place overseas at the certain time intervals. Accordingly, the amount of a transaction which has taken place may be analyzed on the basis of identification information of the transaction or an analysis identifier and a model identifier of the transaction, and default computing resources may be allocated at the first intervals. After default computing resources are set, computing resources for each analysis group may be reallocated in consideration of analysis processing time information of each analysis group.

A limited analysis time may be set for each analysis group, and when an analysis result of a specific analysis group is output beyond the limited analysis time, additional computing resources may be allocated.

The limited analysis time of an analysis group may be determined in consideration of analysis group association information between the analysis group and another analysis group. For example, analysis group 1 may interoperate with analysis group 2 and analysis group 3 to generate a plurality of sub-request transactions, sub-request transaction 1, sub-request transaction 2, and sub-request transaction 3, of a request transaction. Since a response transaction is generated by combining full-text of the plurality of sub-request transactions, all analysis results of analysis group 1, analysis group 2, and analysis group 3 should be generated within a threshold time. In this case, analysis group 1 may be associated with the other analysis groups, analysis group 2 and analysis group 3, to process the request transaction, and when analysis group 1, analysis group 2, and analysis group 3 use default computing resources individually allocated thereto, a limited analysis time of analysis group 1 may be set to the longest one of default analysis time 1, default analysis time 2, and default analysis time 3 required for generating an analysis result.

The additional computing resources may be allocated in consideration of information on an additional analysis time added to the limited analysis time.

The additional computing resources may be returned when a processing time of the analysis group allocated the additional computing resources is maintained at the threshold time or less on the basis of the limited analysis time for the threshold time. In other words, when the processing time of the analysis group allocated the additional computing resources is maintained at the threshold time or less on the basis of the limited analysis time for the threshold time, the analysis group may operate again on the basis of default computing resources.

An artificial intelligence engine number 825 of an analysis group may be determined in consideration of the analysis group queue waiting information 820.

The analysis group queue waiting information 820 may be information on the volume of sub-request transactions waiting in a queue of an analysis group in time units.

In one analysis group, there may be at least one artificial intelligence engine generating the same analysis result. When an analysis result is generated within an input limited sub-request analysis time but a sub-request transaction spends a longer time waiting in a queue to be input, generation of the analysis result may be actually delayed. Therefore, an artificial intelligence engine may be added to an analysis group when it is determined on the basis of the analysis group queue waiting information 820 that there are a first cumulative threshold number of cases or more where a time for which a first cumulative threshold number or more of sub-request transactions are accumulated in a queue is a first cumulative threshold time or more.

The first cumulative threshold number, the first cumulative threshold time, and the first cumulative threshold number of times may be set differently depending on analysis groups. A threshold response time required for returning a response transaction may be set for each request transaction, and when a threshold response time of a request transaction is set to be relatively shorter, the first cumulative threshold number, the first cumulative threshold time, and the first cumulative threshold number of times may be set to be relatively small.

On the other hand, when less than a second cumulative threshold number of sub-request transactions are accumulated for a second cumulative threshold time or more, the artificial intelligence engine may be deleted from the analysis group.

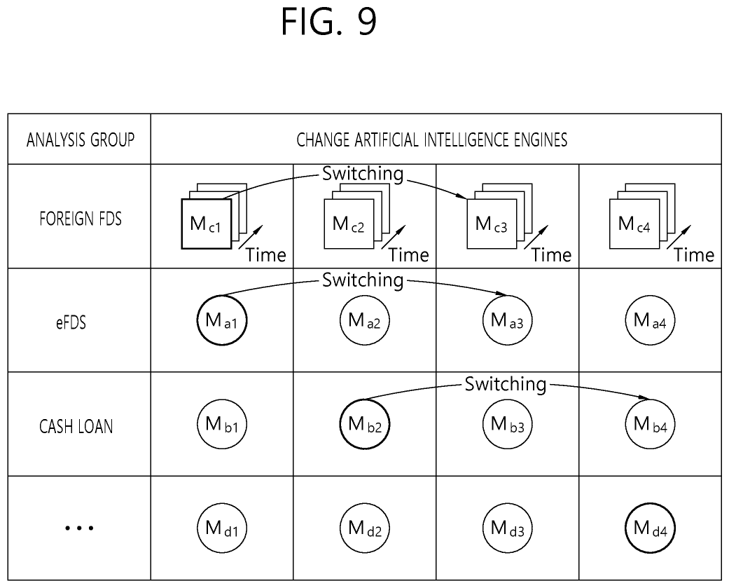

FIG. 9 is a conceptual diagram illustrating an artificial engine exchange method according to an exemplary embodiment of the present invention.

FIG. 9 shows a method of exchanging artificial intelligence engines through performance comparison between artificial intelligence engines.

Referring to FIG. 9, an artificial intelligence engine may be generated for each analysis group, and a performance comparison may be made between a target artificial intelligence engine which is used in a current analysis group and a candidate artificial intelligence engine generated by an artificial intelligence engine generator.

For example, the target artificial intelligence engine and the candidate artificial intelligence engine may be trained for each time period and each variable, and one of the artificial intelligence engines having the highest score for an analysis result may operate as a target artificial intelligence engine. The target artificial intelligence engine and the candidate artificial intelligence engine may be retrained at certain time intervals, and a score comparison may be made between the retrained target artificial intelligence engine and candidate artificial intelligence engine.

In the present invention, a score comparison may be made for each time and each variable, and an artificial intelligence engine having the highest score for each time and each variable may operate as a target artificial intelligence engine.

A target artificial intelligence engine of an analysis group may vary depending on a time at which a transaction is input, or may be set in consideration of an input transaction. For example, artificial intelligence engine A may operate as a target artificial intelligence engine in a first time period, and artificial intelligence engine B may operate as a target artificial intelligence engine in a second time period. Also, when a specific analysis group outputs an analysis result on the basis of inputs of sub-request transactions generated by different transaction service parts (a first transaction service part and a second transaction service part), artificial intelligence engine C for processing a sub-request transaction of the first transaction service part and artificial intelligence engine D for processing a sub-request transaction of the second transaction service part may operate together in the specific analysis group.

A target artificial intelligence engine based on time and a target artificial intelligence engine based on a transaction service part may be set on the basis of the foregoing score.

Also, according to an exemplary embodiment of the present invention, retraining may be performed to update an artificial intelligence engine based on time.

Candidate artificial intelligence engines for a target artificial intelligence engine may include an engine obtained by retraining the target artificial intelligence engine. Therefore, a retraining result of the target artificial intelligence engine may be compared as a candidate artificial intelligence engine with the target artificial intelligence engine that has not been retrained, to determine whether to change the artificial intelligence engines.

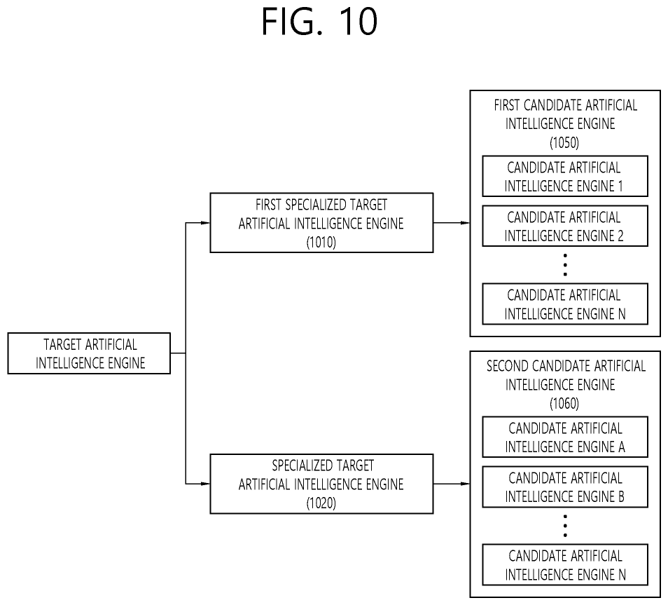

FIG. 10 is a conceptual diagram illustrating an artificial intelligence engine specialization method according to an exemplary embodiment of the present invention.

FIG. 10 shows specialization of an artificial intelligence engine for generating an analysis result in an analysis group.

Referring to FIG. 10, an artificial intelligence engine may be specialized when a target artificial intelligence engine has different scores for specific variables.

For example, analysis result scores of an existing target artificial intelligence engine regarding card transactions of all age brackets may not differ according to each age bracket, but an analysis result score regarding a specific age bracket may be relatively low due to a specific issue (a change in the specific age bracket's pattern of consumption).

In this case, the target artificial intelligence engine may be specialized as a first specialization target artificial intelligence engine 1010 for the age brackets other than the specific age bracket and a second specialization target artificial intelligence engine 1020 for relatively increasing the score of an analysis result for the specific age bracket.

A specialized target artificial intelligence engine which is generated by specializing the target artificial intelligence engine may be termed a specialization target artificial intelligence engine.

When specialization target artificial intelligence engines are generated by specializing the target artificial intelligence engine, each specialization target artificial intelligence engine may be specialized as candidate artificial intelligence engines and separately trained.

During a threshold specialization period after a plurality of specialization target artificial intelligence engines are generated by specializing the target artificial intelligence engine, the plurality of specialization target artificial intelligence engines and scores of candidate artificial intelligence engines for the plurality of specialization target artificial intelligence engines may be determined for all specialized variables. For example, it may be assumed that there are a first specialization target artificial intelligence engine 1010 applied to age brackets other than twenties and a second specialization target artificial intelligence engine 1020 applied to twenties. In this case, first candidate artificial intelligence engines 1050 may be present for the first specialization target artificial intelligence engine 1010, and second candidate artificial intelligence engines 1060 may be present for the second specialization target artificial intelligence engine 1020.

In the case of a transaction of a person in his or her twenties, during a threshold specialization period, the second specialization target artificial intelligence engine 1020 and the second candidate artificial intelligence engines 1060 may be scored, and the first specialization target artificial intelligence engine 1010 and the first candidate artificial intelligence engines 1050 may also be scored.

When the scoring results indicate that any one of the first specialization target artificial intelligence engine 1010 and the first candidate artificial intelligence engines 1050 has a higher score than the second specialization target artificial intelligence engine 1020 and the second candidate artificial intelligence engines 1060, the first specialization target artificial intelligence engine 1010 and the second specialization target artificial intelligence engines 1020 which have been specialized may be combined.

On the other hand, when the scoring results during the threshold specialization period indicate that none of the first specialization target artificial intelligence engine 1010 and the first candidate artificial intelligence engines 1050 has a higher score than the second specialization target artificial intelligence engine 1020 and the second candidate artificial intelligence engines 1060, the specialization is settled, and the first specialization target artificial intelligence engine 1010 and the second specialization target artificial intelligence engines 1020 may generate candidate artificial intelligence engines and operate as separate target artificial intelligence engines. Here, a transaction for a specialized variable may be scored regarding only another specialization target artificial intelligence engine and a candidate artificial intelligence engine for the specialization target artificial intelligence engine.

In this way, when a transaction is temporarily changed, transaction analysis performance can be improved, and it is possible to prevent waste of computing resources by preventing unnecessary specialization of an artificial intelligence engine.

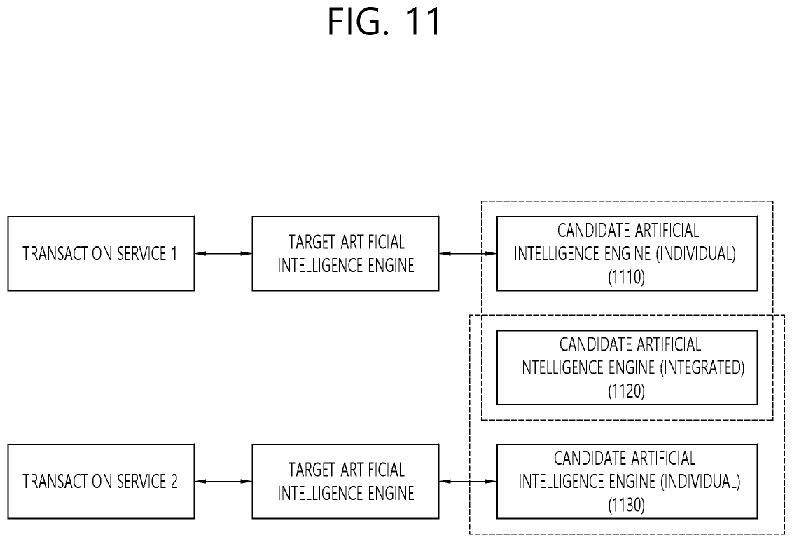

FIG. 11 is a conceptual diagram illustrating an operation of a distributed transaction analysis system based on a plurality of transaction service parts according to an exemplary embodiment of the present invention.

FIG. 11 shows an operation of a distributed transaction analysis system for providing analysis results of a plurality transaction services.

Referring to FIG. 11, the distributed transaction analysis system may generate an analysis group according to an analysis result required for each of a plurality of transaction services and perform training on the basis of artificial intelligence engines.

In the case of analysis groups that generate the same variable and the same analysis result, the distributed transaction analysis system may generate candidate artificial intelligence engines by performing training on the basis of transactions generated by a plurality of transaction services. Also, a candidate artificial intelligence engine may be additionally generated by performing training on the basis of all the transactions received from the plurality of transaction services.

A candidate artificial intelligence engine generated by performing training on the basis of transactions taking place in one transaction service may be termed a candidate artificial intelligence engine (individual) 1110 or 1130, and a candidate artificial intelligence engine generated by performing training on the basis of transactions taking place in a plurality of transaction services may be termed a candidate artificial intelligence engine (integrated) 1120.

A score comparison may be made between a target artificial intelligence engine and not only the candidate artificial intelligence engines 1110 and 1130 but also the candidate artificial intelligence engine (integrated) 1130. When the candidate artificial intelligence engine (integrated) 1130 has a relatively high score, the target artificial intelligence engine may be replaced with the candidate artificial intelligence engine (integrated) 1130.

When the number of transaction services participating in the system increases in this way, it is possible to provide an analysis result with high reliability using training data in an integrative manner.

The embodiments of the present invention described above may be implemented in the form of program instructions that can be executed through various computer units and recorded on computer readable media. The computer readable media may include program instructions, data files, data structures, or combinations thereof. The program instructions recorded on the computer readable media may be specially designed and prepared for the embodiments of the present invention or may be available instructions well known to those skilled in the field of computer software. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and execute the program instructions. Examples of the program instruction include machine code generated by a compiler and high-level language code that can be executed in a computer using an interpreter and the like. The hardware device may be configured as at least one software module in order to perform operations of embodiments of the present invention and vice versa.

While the present invention has been described with reference to specific details such as detailed components, specific embodiments and drawings, these are only examples to facilitate overall understanding of the present invention and the present invention is not limited thereto. It will be understood by those skilled in the art that various modifications and alterations may be made.

Therefore, the spirit and scope of the present invention are defined not by the detailed description of the present invention but by the appended claims, and encompass all modifications and equivalents that fall within the scope of the appended claims.

What is claimed is:

1. A method of controlling a distributed transaction analysis system for analyzing a transaction on the basis of a distributed workflow, the method comprising:
controlling, by a serving container manager (SCM) for the distributed transaction analysis system, a plurality of analysis groups included in a worker part; and
controlling, by the SCM for the distributed transaction analysis system, full-text division of a codec.

2. The method of claim 1, wherein each of the analysis groups includes at least one artificial intelligence engine, and
the SCM determines addition and deletion of the analysis groups included in the worker part and a number of artificial intelligence engines which are included in the analysis groups and loaded into a memory to operate.

3. The method of claim 2, wherein the SCM controls the codec by considering a plurality of sub-request transactions input to the artificial intelligence engines so that full text of a request transaction input from a transaction service part is divided by the codec.

4. A distributed transaction analysis system for analyzing a transaction on the basis of a distributed workflow, the distributed transaction analysis system comprising a serving container manager (SCM) configured to control a plurality of analysis groups included in a worker part and control full-text division of a codec.

5. The distributed transaction analysis system of claim 4, wherein each of the analysis groups includes at least one artificial intelligence engine, and
the SCM determines addition and deletion of the analysis groups included in the worker part and a number of artificial intelligence engines which are included in the analysis groups and loaded into a memory to operate.

6. The distributed transaction analysis system of claim 5, wherein the SCM controls the codec by considering a plurality of sub-request transactions input to the artificial intelligence engines so that full text of a request transaction input from a transaction service part is divided by the codec.
